(19) United States
(12) Patent Application Publication
(10) Pub. No.: US 2020/0136831 A1
(43) Pub. Date: Apr. 30, 2020

(54) API AND DOMAIN SPECIFIC LANGUAGE FOR 1 TO MANY, STATE-BASED, GRANULAR, TERMS AND CONDITIONS ACCEPTANCE

(71) Applicant: CA, Inc., Islandia, NY (US)

(72) Inventors: Debra Danielson, Islandia, NY (US); Brendan Doherty, Islandia, NY (US)

(21) Appl. No.: 16/176,194

(22) Filed: Oct. 31, 2018

(51) Int. Cl. H04L 9/32; H04L 9/06; G06F 17/30

(52) U.S. Cl. CPC H04L 9/3247; G06F 17/30979; H04L 9/0643

(57) ABSTRACT

Provided is a process that includes: determining whether to execute an asset based on records documenting requirements for the asset. A first one of the records published to a blockchain and implicating requirements published to the blockchain in at least one record, wherein determining whether record holders agree to execute the asset comprises: accessing the first record, verifying the first record published to the blockchain has not been tampered with subsequent to publishing, and identifying requirements and criteria of the first record; accessing the second record and identifying requirements and values of the second record; and verifying each of the requirements and the criteria in the first record are satisfied by respective criteria and values specified in the second record. Agreement to execution of the asset is published to the blockchain upon determining the requirements and criteria of the first record are satisfied by the second record.

### CROSS-REFERENCE TO RELATED APPLICATIONS

No reference to related applications is presented herein.

### BACKGROUND

### 1. Field

The present disclosure relates generally to a data structure and application programming interface, and more specifically, to execution of smart contracts configured to establish immutable agreements.

### 2. Description of the Related Art

The relationships today between product and service providers and their users is often tenuous. Users are frequently presented during their daily usage of products and services with terms and conditions governing uses of those products and services. Additionally, those users must accept those terms and conditions prior to being able to use the products or services to which the terms and conditions pertain. Oftentimes, the user is presented with only the options to take it or leave it so to speak, meaning that if the user does not agree with a given term or condition they must either accept or forgo using the product or service. Accordingly, users view acceptance of terms and service as a formality with little regard to what they are legally committing themselves to through acceptance. Indeed, most users simply scroll through the terms and conditions or otherwise check a box to indicate their acceptance without reviewing them at all.

As terms and conditions are often written in legal jargon, and many pages long, even if users did not view their acceptance as a mere formality, few users would understand the requirements therein. Further, even where users understand the terms and conditions, when a user does not agree with a given requirement they are still in the position where they must take the terms and conditions as they stand or forgo use of the product or service. Oftentimes, there exists no competing product or service which that user may utilize as an alternative, such as for internet services where there may only exist one or two internet service provider within the user's area. These realities present issues for both users and product and service providers.

Terms and conditions serve to protect product and service providers such that they can offer products users enjoy, and which most users utilize in permitted ways. However, some users utilize those products or services in ways that are not permitted in the terms and conditions by the product and service providers. Sometimes a lawsuit may precipitate from a user's use of a product or service in a manner prohibited by terms and conditions. Here, it is unlikely that a judge or jury would believe that a typical user read and understood the terms and conditions because they “agree” daily to many things that they do not actually understand. In some of those instances, a user may have believed they were acting in good faith without malicious intent, and simply ran afoul of requirements in a legal document they neither read nor would understand. In other instances, a user may have intentionally breached the terms and conditions, but the judge or jury may remain receptive to arguments to the contrary because of how most users view terms and conditions.

Further, terms and conditions may also serve to protect users, as they may specify requirements which the product and service providers must abide. Oftentimes, these requirements are related to user privacy and how/what data product and service providers can collect, distribute, or otherwise use that pertains to the user. Users are becoming increasingly concerned with their privacy and how/what data product and service providers collect, distribute, or otherwise use that pertains to the user. However, because users are unable to reasonably decipher terms and conditions governing those products and services, they remain largely in the dark as to what data is being collected and how that data is being used.

### SUMMARY

The following is a non-exhaustive listing of some aspects of the present techniques. These and other aspects are described in the following disclosure.

Some aspects include a process including: receiving, with one or more processors, a request to execute an asset between at least two record holders having documented one or more requirements from a set of requirements codified in a domain-specific language in respective records; the records documenting requirements associated with the asset, and at least some of records and records including requirements of the domain specific language are published to a tamper-evident, immutable, decentralized data store; determining, with one or more processors, whether to execute the asset based on a comparison of a first record documenting requirements associated with a given asset of a given type and a second record documenting accepted requirements associated with the type of asset, each record published to a tamper-evident, immutable, decentralized data store, wherein determining whether to execute the asset comprises: accessing the first record, the first record including a hash digest based on requirements associated with the asset, the hash digest implicating a plurality of requirements published to the tamper-evident, immutable, data store in at least one record, verifying the first record has not been tampered with subsequent to publishing by verifying that the first record is consistent with a set of cryptographic hash values based on the first record, at least some of the cryptographic hash values also being based on other records, identifying, within the first record, one or more criteria associated with one or more of the requirements; accessing the second record, the second record including a hash digest based on accepted requirements associated with the type of asset, the hash digest implicating a plurality of requirements published to the tamper-evident, immutable, data store in at least one record, identifying, within the second record, one or more values associated with one or more of the requirements, verifying, for each of the plurality of requirements implicated in the first record, that the second record implicates a same requirement to satisfying the plurality of requirements implicated in the first record, verifying, for each of the criteria in the first record, that the second record includes a value satisfying the criteria specified in the first record, and in response to the determination and the request, either: causing, with one or more processors, one or more computing devices to publish to the tamper-evident, immutable data store an agreement to execution of the asset upon determining the requirements and the criteria of the first record are satisfied by the second record, or causing, with one or more processors, one or more computing devices to not execute the asset upon determining the requirements and the criteria of the first record are not satisfied by the second record, wherein the one or more computing devices transmit a delta indicating at least one of a requirement or requirement and criteria of the first record not satisfied by the second record.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block logical and physical architecture diagram of a computing environment for establishing agreement to assets on a blockchain in accordance with some embodiments of the present techniques;

FIG. 2 illustrates an example record of a domain specific language in accordance with some embodiments of the present techniques;

FIG. 3A illustrates an example record of an asset based on a domain specific language in accordance with some embodiments of the present techniques;

FIG. 3B illustrates an example record of user preferred requirements for agreeing to assets based on a domain specific language in accordance with some embodiments of the present techniques;

FIG. 4A is a flowchart of an example of a process executed by an authority or a computing node with a smart contract in accordance with some embodiments of the present techniques;

FIG. 4B is a flowchart of an example of a process executed by an authority or a computing node with a smart contract in accordance with some embodiments of the present techniques;

FIG. 5 is a block diagram of an example of a computing device with which the above-describe techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of software development tooling. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Terms and conditions and other types of agreements or governing documents may be characterized as an asset and, in many cases, as constituted by the requirements therein. Execution of these types of assets by a given party, or by multiple parties, signifies their mutual agreement to those requirements. Assets may also be entirely different from those types of documents mentioned above, for example, rather than being representative of a document at all, an asset may be a list of requirements to be fulfilled or otherwise upheld in an entirely different context. One example might be requirements for storage and compute capability or capacity of a server farm or cloud computing platform, requirements for facilitating the movement of tangible goods from one location to another, and so on.

In each case, different entities may utilize proprietary assets, and those proprietary assets are often ignored or misunderstood by the users that agree to those assets. For example, users may be required to agree to an asset in conjunction with and prior to retaining communication services with service providers, being able to utilize an application, being able to utilize a given feature of an application, being able to utilize a physical product (e.g., such as mobile device with a network connection), utilize a feature on a website or other online resource, and may other products and services. Further, users may be required to agree to an asset in conjunction with an update or a change in one to one of those products or services, such as prior to updating or prior to using an updated version of an application, a new version of an operating system or other update pushed to the mobile device, modifying or otherwise changing a service, and in many other cases.

Increasingly, as users simply agree to such assets without reading or otherwise attempting to understand them, product and service providers have devised different ways to at least collect some indication that users have read over the asset prior to agreement. For example, oftentimes a user may be required to open, download, scroll through, or otherwise interact with an asset in one way or another prior to their agreement thereto, thereby at least providing some indication that they “reviewed” the asset. However, users are presented with such assets so frequently and those assets are often so lengthy that providing such indications are just an additional hoop for users to jump through without any change to the likelihood they review or understand what the assets entail. Most users, if not product and service providers themselves, would readily admit that few users actually read, let alone understand, what they are agreeing to through their agreement to those assets.

To mitigate the above-described issues and other issues described below (and that will be apparent to a reader of ordinary skill in the art), some embodiments help users and businesses, like product and service providers, establish assets using blockchain technology to drive improved user experience and reduced cost to businesses at a lower risk to both users and businesses relative to traditional approaches. Some embodiments record information about assets in a blockchain (or other directed acyclic graph of cryptographic hash pointers).

As an asset may serve to protect both an entity providing products and service and users alike, there exists a need to improve ways in which assets are created by those entities, presented to users, and ultimately agreed to, including negotiation of aspects within assets. Accordingly, there also exists a need to better describe aspects within assets such that users can more easily review and understand them. Embodiments may provide an ontology of sets of requirements and their respective criteria that may be specified within assets including a given context. Thus, for a given context, requirements may be organized according to a given ontology, or domain specific language, and those requirements may be at least somewhat common to the various entities that create assets within the given context. In other words, rather than 10, 50, 100, or 1000 different entities referring to a similar aspect of an asset in as equally many different ways, if not more, such as where those entities may have different assets for different products, a domain specific language may greatly reduce that number. For example, the domain specific language may include one way of describing that aspect, like a requirement, for which there may be a specific set or range of criteria that can be specified for that requirement. The different requirements corresponding to respective aspects of an assent may include one or more criteria or no criteria.

In an example of terms and conditions, multitudes of information companies specify ways in which they collect and/or utilize user data, such as by collecting global positioning satellite (GPS) location data representative of a user's location from a mobile device and providing information to the mobile device responsive that location. Although the terms and conditions of respective information companies may differ in their specific language, each may express the above concept. The above concept, and other concepts, within a given domain can be expressed in a domain specific language that includes the various requirements common to that domain and the criteria, or values, of those requirements. For example, “user data collected: Location<GPS, WiFi, Cellular>; User/Account Identifier<email>; Mobile Device Identifier<telephone number, IMEI>; etc.,” “user data used: Location<GPS, WiFi, Cellular>; Mobile Device Identifier<telephone number>,” “user data shared with partners: Location; Mobile Device Identifier,” “user data stored: Location<X minutes/years/forever>,” “anonymized user data stored: User/Account Identifier<email>, Mobile Device Identifier<telephone number, IMEI>,” and so on. Various entities may specify requirements and criteria, like those above, within the domain specific language for the context of user privacy. In turn, those requirements and criteria may be specified by an entity in a record describing a given asset covering, at least in part, the context of user privacy. Similarly, a user may specific which requirements and their criteria to which they are willing to agree in the context of user privacy in a record.

Which requirements and which criteria are specified may be cross relational between one or more formats specified by the domain specific language. For example, a communication format for communication or reference of one or more requirements and criteria, may be numerical only, or also include characters, can be translatable to other informational formats as specified by the domain specific language, such as a format to present the requirement and criteria for selection or review, and another format, which may be application dependent, like a legal format or business type agreement that includes agreed upon legal or business language around those requirements and criteria. An example communication format, such as a vector, may represent a requirement and its criteria or represent a set of requirements and their respective criteria at a low level. An intermediate format may express requirements and criteria at a higher level, like in the above example for user data, such that general users can understand and review requirements and their criteria. Another format may express requirements and criteria at another level, like at a legal level. Records may be created in one or more of these formats and cross-format relateble by the domain specific language, which itself may be stored in a record. The domain specific language, including those different formats, may be mutually agreed upon, like a standard, by entities having a concern within the context of use of the domain specific language. Thus, the requirements and criteria of an asset specified or agreed upon at one level may extend across the different levels, and records can provide verifiable documentation of the who/what/when for execution of an asset, e.g., in one or more records. A blockchain, by way of those records, may include or verifiably document requirements of assets and agreements pertaining to those assets in a domain specific language including relatively fine-grained information about the requirements and their criteria.

Identification of which requirements and which criteria are specified or agreed upon may be achieved in different ways, such as by various identifiers, or other formatting specified by the domain specific language. Thus, the domain specific language for a given context may be extensible and revised to include new concepts or remove old ones, such as by adding or removing identifiers. However, as agreements on assets are reached at particular points in time, there exists a need to maintain an accurate representation of a domain specific language throughout those revisions, like in a database, such that agreements predicated upon certain requirements and certain criteria in an asset as specified by the domain specific language at a given time remain verifiable at another time. Some embodiments may include for each version or record of state of a domain specific language a cryptographically signed hash digest including the version or record of state (or the version/record itself) of the domain specific language, signed using public key infrastructure (PKI) by a participant (or participants or an authority) of the system. Storage of, which may also be referred to as publication of, a record of state of the domain specific language to the blockchain may serve as the authoritative version or verification of an authoritative version thereof at a given point in time.

Thus, an asset can be composed of multiple requirements which may be shared, in part, across multiple other assets and those requirements can be codified in a domain specific language referenceable or at least verifiable by an authoritative record. Additionally, requirements and criteria for one or more requirements can be codified in the domain specific language, and the criteria may be expressed as a field which may be filled with one or more specific values or a range of values also codified in the domain specific language. Thus, for example, a requirement A may include a first criteria having permitted values X, Y, or Z, and/or 30 or a range of values like 1-10. In turn, a vector like <RqID:A,X> may be representative of the requirement A having a value X for the first criteria and a vector like <RqID:A,10> may be representative of the requirement A having a value 10 for the first criteria. Multiple vectors may be combined to express multiple different requirements in different ways. In some embodiments, the vector includes placeholders for each requirement/criteria such that individual requirements need not be called out in the vector. Some embodiments may include for an asset a cryptographically signed hash digest of the version or record of state of the domain specific language, requirements and/or criteria (e.g., as a vector), signed using public key infrastructure (PKI) by a participant of the system. Storage of, which may also be referred to as publication of, a record of the asset to the blockchain may serve as the authoritative version or verification of an authoritative version thereof at a given point in time.

To facilitate relatively low-latency reads, some embodiments may execute the blockchain's consensus algorithm on a permissioned network, substituting proof of stake or proof of authorization for proof of work. To facilitate broad adoption, some embodiments may integrate permissioned and permission-less implementations.

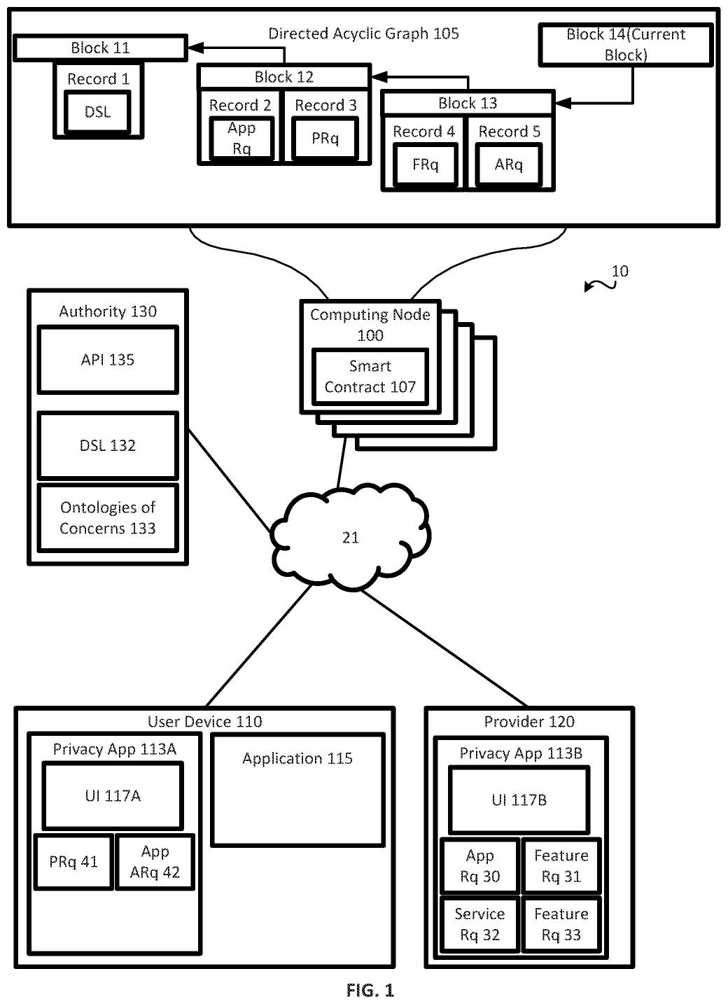

FIG. 1 is a block diagram depicting an environment 10 in which users and providers of products and services interact in at least some example embodiments. For example, FIG. 1 depicts a user device 110 and a provider 120 which may communicate directly or indirectly over a network 21. In some embodiments, the network 21 includes the public Internet and a plurality of different local area networks.

In some embodiments, a provider 120 may host an application on a server. A user of the user device 110 may utilize the user device to obtain the application 115 over the network 21, such as by downloading the application. The user may elect to install the application 115 to the user device 110 to utilize one or more functions provided by the application. As an example, the application 115 can be a map application which the user may utilize to view road maps, traffic data, locations of businesses, and get directions between two or more locations. To support that functionality, the provider 120 may host an application programming interface (API) by which the application 115 can submit requests to retrieve data for performing one or more of the above functions. To provide that functionality, the provider 120 may require the user of the user device 110 to agree to one or more terms and conditions governing the use of the API. For example, the terms and conditions may restrict use of the API to personal use and other legal purposes. Traditionally, this might occur by the application 115 requiring the user to agree to those terms and conditions within an interface upon execution of the application on the user device 110 or otherwise agree to those terms and conditions during a registration process with the provider 120. Once the user agrees to the terms and conditions via the user device 110, the provider 120 supports the application 115 on the user device, such as by providing map and direction data via the API in response to queries received from the application for that data.

In some cases, functionality of the application 115 may be enhanced by the provider 120 through the use of user specific data, like location data. For example, the application 115 may transmit a location as reported by the user device 110 to the provider 120 to retrieve directions to another location based on the reported location. The provider 120 may collect and store the location data transmitted by the application 115 in association with an identifier of the user/user device 110, such as to provide recommendations associated with the reported location or the destination location. The application 115 may report location on a continual basis such that the provider 120 may provide real-time traffic and other data back to the application for alerting the user, such as to traffic incidents and the like. The terms and conditions agreed to by the user can govern provider 120 collection and use of the user data. Some applications 115 and/or operating systems of user devices 110 provide options for restricting the collection/reporting of such data by the application 115 to the provider 120. However, restricting collection/reporting of such data may prohibit availability of one or more of the above features of the application 115, either by the application 115 itself or by the provider 120 disabling portions of API functionality.

The above example is illustrative as a provider 120 may provide various different applications, services, and/or products (like the user device 110 itself). In some embodiments, the provider 120 represents one or more computing devices associated with a provider of a product or service. For example, the provider 120 may be a server, like a web server, or backend server, or other type of server, and include a network interface, a central processing unit, and memory.

Similarly, a user may utilize those applications, services, and/or products in multitudes of different ways via a user device 110, such as by an application on a mobile device, personal computer, or web server, through a webpage, by way a connection to the provider (e.g., internet or other networked services), or the product or service may be a user device 110 itself. In many cases, the user device 110 is configured to consume a product or service of the provider 120, like application 115. To that end, the user device 110 may include a network interface, a central processing unit, and memory.

Generally, the memory of at least one device, or a shared memory, may store a copy of program code for an application, like a privacy application 113 or application 115, that when executed by the CPU provides functionality ascribed to that application. In some embodiments, the different software components may communicate with one another or with software components on other computing devices via a network interface, by which messages are sent over the network 21. For example, to/from an API or to/from nodes of a decentralized computing platform. In some instances, there the user device itself is the provided product, one or more application may be preinstalled by a provider of the device.

Where use of those applications, services, and/or products are governed by or otherwise include assets agreed upon between multiple parties, like an agreement to the terms and conditions governing use of application 115 between the user of the user device and the provider 120 of that application, those assets and agreements thereon may be handled in inventive ways. Those inventive ways provide numerous benefits previously not afforded to users and providers.

Additionally, the environment 10 depicted in FIG. 1 can include, in some embodiments, an authority 130 and at least one computing node 100 for improving interactions between users and providers, such as by facilitating agreement upon assets. Depending on the embodiments, the authority 130 may communicate with a computing node 100 and one or more other entities over the network 21. Similarly, the computing node 100 may communicate with one or more other entities over the network 21.

The authority 130 may be a trusted party that develops aspects of a domain specific language and provides software tools which users and/or providers may utilize to facilitate agreements upon different assets. In some embodiments, the authority 130 publishes the domain specific language such that any user and/or provider may review, access, and/or use the domain specific language. In some embodiments, users and/or providers may utilize tools provided by the authority 130 and/or develop their own to review, access, and/or use the domain specific language. In some embodiments, the authority 130 tracks metrics related to the use of the domain specific language.

In some embodiments, the computing node 100 is a computing node of a decentralized computing platform comprising many computing nodes. While only one computing node 100 is shown in detail, embodiments may include many more computing nodes, for instance, numbering in the dozens, hundreds, or thousands or more. In some embodiments, one or more of the computing nodes 100 may be rack-mounted computing devices in a data center, for instance, in a public or private cloud data center, or personal computing devices or servers in users' homes. In some embodiments, various ones of the computing nodes 100 may be geographically remote from one another, for instance, in different data centers and different users' homes, and geographically remote from other nodes and the other components illustrated. Thus, in some embodiments, the computing platform that the computing nodes operate is relatively to very decentralized where at least some of the computing nodes are operated by various different entities for various purposes. However, that is not to say that in some embodiments a computing node 100 or nodes may be collocated (or in some cases, all be deployed within a single computer cluster).

In example embodiments where computing nodes are part of a decentralized computing platform comprising many computing nodes it should be recognized that entities like the user device 110, provider 120, and authority 130 need not communicate with any one specific node. Rather, each may communicate with a different one/multiple of the computing nodes of the decentralized computing platform and also may communicate with different ones of the nodes at different times. Further, in some embodiments, one or more of the authority 130, user device 110, and/or provider 120 may be a node, include a node and/or operate a node or subset of functionality of a node, thereby operating as part of the decentralized computing platform or configured to communicate with at least some of the nodes (e.g., to submit and/or retrieve data, not substantially process data).

In some embodiments, the computing node 100 may operate upon various types of information stored by the decentralized computing platform. Examples include a directed acyclic graph 105 of cryptographic hash pointers, such as a blockchain or other tamper-evident, immutable, decentralized data stores. Other examples include various scripts in the scripting language of the decentralized computing platform executable by the computing node 100, for instance with verifiable computing, such that no single computing node 100 needs to be trusted. In some embodiments, these scripts or programs may be referred to as smart contracts 107, a term which should not be confused with a contract in law or other financial instrument. Rather, smart contracts refer to programs executable by the decentralized computing platform, which in some cases may be tamper-evident, immutable decentralized programs loaded to the decentralized computing platform by one of the components of the environment 10. For example, the authority 130 may publish a smart contract 107 to the decentralized computing platform such that the computing node 100 (and/or other nodes) may process information stored in the directed acyclic graph 105, and/or other information, according to one or more operations enumerated in the smart contract. A smart contract 107 can be a contract in the sense that the logic of the smart contract is immutable in some implementations once loaded to the decentralized computing platform and thus serves as a form of a commitment to a particular body of logic.

The term “immutable” should not be read to require that immutable data be written to a form of physical media that prevents subsequent writes (e.g., a ROM or write-once optical media). Rather, the term “immutable” refers to a data structure that does not support modifications to data once written. In some cases, this feature is afforded by making the data structure tamper evident, e.g., computationally infeasible to modify committed data without rendering the data structure internally inconsistent. In some cases, the data structure computational infeasibility of undetectable modifications may be afforded by chaining the above-described cryptographic hash values, such that verification of tampering consumes less than 100,000^{th} of the computing resources (e.g., in time or memory complexity) of computing resources needed to modify the data structure to be consistent with a modified previously written record.

In some embodiments, the smart contracts may be stored in the directed acyclic graph 105 or otherwise published to this data repository, or in some cases, the smart contracts may be stored in a different tamper-evident, immutable, decentralized data store from that of the data upon which the smart contracts operate. One example of a smart contract 107 is described, but it should be emphasized that there may be, and in some commercial implementations likely will be, multiple instances of smart contracts with variations to implement new or different logic. For example, a smart contract 107 may be updated to operate on new or different domain specific language or otherwise incorporate new or different logical operations. In a specific example, a given smart contract may be specific to, e.g., one or more domain specific languages by referencing immutable records of those domain specific languages. A new smart contract referencing the new or other records of domain specific languages may be published such that the new smart contract may operate on those records. This need not be the case, however, as a smart contract may also take one or more arguments referencing a given domain specific language such that it need not be updated to reference a new or other domain specific language. Different embodiments may favor different implementation of smart contracts. Further, in some cases, the smart contracts may be composed of or reference other smart contracts or invoke or draw upon logic implemented outside of the decentralized computing platform. For instance, some smart contracts may interface with the outside world relative to the decentralized computing platform via an authority 130.

In some embodiments, smart contracts, like smart contract 107, may be callable by the various components of the environment 10. Additionally, various components of the environment 10, like the authority 130, may publish new smart contracts callable by the various components and the authority. For example, the components in some cases may execute a peer client application of the decentralized computing platform or otherwise send messages to application program interfaces for performing operations within the decentralized computing platform to call the smart contracts and receive results. In some embodiments, the smart contracts may have an address, for instance, in a data storage address space of the decentralized computing platform, like an address corresponding to a cryptographic hash of program code of the smart contracts. In some embodiments, the smart contracts may accept arguments, such as various variables that may be passed to the smart contract and which may be operated upon by logic of the smart contract. Examples of arguments and their variables may include references, like an address, to data within the decentralized computing platform and/or data for storage within the decentralized computing platform. In some cases, each smart contract may have a respective application program interface with a schema defined in an artifact of the corresponding smart contract that enumerates arguments that are required, arguments that are optional, default values for arguments, types of those arguments, and the like.

In some embodiments, the directed acyclic graph 105 comprising cryptographic hash pointers may provide a tamper-evident, immutable, decentralized data store to which the smart contracts are published and to which records accessed by the smart contracts are published, which in some cases may include output of the smart contracts as well as inputs to the smart contracts. In some embodiments, publishing a record or smart contract to the directed acyclic graph 105 may include storing all of the information of that record or smart contract (e.g., the program code of the logic of the smart contract that is executed by the computing nodes 100 (e.g., in a virtual-machine of the decentralized computing platform corresponding to a target of byte code into which smart contracts are interpreted) in content of nodes (e.g., a node in a tree of nodes, like a Merkle tree, and a given tree may be stored in a block) of the directed acyclic graph of cryptographic hash pointers. Cryptographic hash pointers pointing to those nodes include cryptographic hash values (as part of node content of the node that is pointing) that are based on node content (of the node to which is pointed) that includes the stored information (e.g., a record), thereby defining a chain of cryptographic hash pointers that becomes increasingly computationally expensive to modify (while remaining internally consistent) in the event of attempted tampering as the chain increases in length or tree increases in size. In some embodiments, a plurality of different directed acyclic graphs of cryptographic hash pointers may store different subsets of the information, may store replicated instances of the information, or in some cases a single directed acyclic graph of cryptographic hash pointers may store all of this information. In some cases, the directed acyclic graph is a sub-graph of a larger graph with a cycle, and in some cases the directed acyclic graph includes unconnected subgraphs.

In some embodiments, publishing information to the directed acyclic graph 105 of cryptographic hash pointers is achieved by storing a cryptographic hash digest of the information in node content of the directed acyclic graph of cryptographic hash pointers. In some embodiments, node content may be a record of published information. In some cases, that record of information is cryptographic hash (or hashes) of record information stored outside of the directed acyclic graph 105 of cryptographic hash pointers, but that outside record information and an appended timestamp and address in a data store (e.g., like that of an authority 130 or other entity) may be input to a cryptographic hash function to output a cryptographic hash value. That cryptographic hash value (or other hash digest) may be stored as node content of the directed acyclic graph 105 of cryptographic hash pointers. The record of published information (or record information stored outside of the graph 105) may then be verified as having been untampered with by recalculating the cryptographic hash value based on the asserted address, time, and record content and comparing the recalculated cryptographic hash value to the cryptographic hash value stored in the directed acyclic graph of cryptographic hash pointers. Upon determining that the hash values match, the record may be determined to have not been subject to tampering, or upon determining that the values do not match, the record may be determined to have been tampered with. Further, to verify that the cryptographic hash value in the directed acyclic graph has not been tampered with, some embodiments may recalculate cryptographic hash values along a chain of cryptographic hash pointers to confirm that the recalculated values match those in the directed acyclic graph, thereby indicating the absence of tampering (or upon detecting a mismatch, indicating the presence of tampering).

Embodiments may publish different information in different ways. For example, a domain specific language may be published to the graph 105 in at least one record 1 in its entirety. Alternatively, a cryptographic hash of the domain specific language or components thereof, e.g., a cryptographic hash digest, may be published to the graph 105 in at least one record 1, such that its authenticity or components thereof may be verified. For example, in some embodiments, a given record may be published by storing a portion of the record in node content and storing a cryptographic hash digest based on the rest of the record as node content, with the rest of the record being stored outside of node content, for instance as a file in a data store (e.g., of the authority 130) that is accessible via network 21. In some embodiments, the on-chain portion stored as node content may be a machine-readable portion, such as a portion of key-value pairs in dictionaries encoded as a hierarchical data serialization format, like JavaScript™ object notation (JSON) or extensible markup language (XML). In some embodiments, the off-chain portion may be a human-readable format including unstructured natural language text that describes in prose information of the record. Or in some embodiments, this allocation may be reversed, intermingled, or otherwise differently arranged, which is not to suggest that any other feature herein is not also amenable to variation relative to the arrangements described.

In some embodiments, content of nodes of the directed acyclic graph 105 of cryptographic hash pointers may be verified as having not been subject to tampering by determining whether that content is consistent with one or more chains, or other associative data structures (e.g., trees), of cryptographic hash pointers of the directed acyclic graph. In some embodiments, nodes of the directed acyclic graph of cryptographic hash pointers may include as node content a node identifier (e.g., an address in the graph) that distinguishes a node from other nodes of the graph, identifiers or one or more other nodes of the graph to which a cryptographic hash pointer of that node points, and an associated cryptographic hash values based on node content of those other identified nodes to which the cryptographic hash pointers point (in some cases, the pointing is from one and only one node to one and only one node for adjacent nodes). As additional nodes are appended to the directed acyclic graph, a chain of cryptographic hash pointers may be formed such that each subsequent node includes as node content one or more cryptographic hash values based upon some, and in some cases all of the previously published information published to the directed acyclic graph of cryptographic hash pointers.

The directed acyclic graph 105 of cryptographic hash pointers need not be referred to as a graph, or as having nodes or edges, in program code to constitute a graph, provided that a data structure affords the same or similar functionality, even if that data structure bears different labels. Similar qualifications apply to assets and records described herein. For instance, graphs may be encoded in objects in object-oriented programming environment, key-value pairs, entries in a relational database, documents encoded in a hierarchical data serialization format, or combinations thereof, without being labeled as graphs.

In some embodiments, to expedite write operations (and in some cases, afford faster reads or verifications of reads), some embodiments may consolidate writes to the directed acyclic graph 105 of cryptographic hash pointers. For instance, some embodiments may form sub-graphs of directed acyclic graphs of cryptographic hash pointers that are collectively appended to an extant, larger directed acyclic graph of cryptographic hash pointers. In some embodiments, the directed acyclic graph 105 of cryptographic hash pointers may include a linked list, tree, or skip list of the sub-graphs. In some embodiments, the sub-graphs may be referred to as blocks, e.g., example blocks 11-14 as shown, with block 14 being current and blocks 11-13 storing one or more records pertinent to the examples described herein, and each may include 2, 4, 8, 16, 32, 64, 128, 256, 512, 1028, or more or less nodes, and one or more of those nodes may include node content, such as a record or multiple records, e.g., example records 1-5 as shown.

In some embodiments, the appended sub-graphs may be implemented with a particular type of directed acyclic graph that affords relatively fast verification in addressing of published information. In some embodiments, the sub-graphs that are collectively appended may be binary trees, quad trees, radix trees, or the like. In some embodiments, the sub graphs are Merkel trees, such as Patricia trees (lists herein should not be read as necessarily specifying mutually exclusive categories). In some embodiments, published information (e.g., records) may be stored as node content of leaf nodes of a binary tree data structure that is collectively appended to the directed acyclic graph of cryptographic hash pointers upon completion of the tree data structure (e.g., achieving a threshold number of nodes). Or in some cases, intermediate nodes of the tree data structure may include nodes having content in which published information is stored.

In some embodiments, the directed acyclic graph of cryptographic hash pointers 105 is formed by a chain of cryptographic hash pointers between nodes that include as node content a root node of an appended tree data structure or cryptographic hash value based on node content of a root node, in some cases further including a unique identifier of the tree in the chain and a timestamp, for instance in a block header of a block in a blockchain. In some embodiments, an initial node in the chain may include a randomly selected, relatively high entropy value that serves as a source of entropy for each subsequent entry in the chain. In some embodiments, to afford faster navigation along the chain, some chains may include a skip list or index of blocks or entries in blocks.

Various records may be published to the directed acyclic graph 105 of cryptographic hash pointers. In some embodiments, these records may include information pertaining to a domain specific language on which an asset relies, requirements and criteria for an asset, an asset, and other the information discussed herein. In some embodiments, the records may be indexed in different ways. For example, users may publish via a user device 110 a record of their preferred requirements for an asset, and optionally build upon or specify new preferred requirements for an asset in a subsequent record. Published records of preferred requirements by users may be indexed such that metrics associated with those records may be analyzed. A published record of preferred user requirements may include a header indicating that the record includes preferred user requirements and indexed accordingly. In another example, providers 120 may publish a record of their requirements pertaining to use of a given one of their products or services, like application 115. In some embodiments, those requirements may be segmented into different requirements pertaining to use of different features or service levels of a product or service, like different features of an application 115.

By way of example, an authority 130 may determine a domain specific language based on at least one ontology of concerns 133. For example, a domain specific language, DSL 132, may be based on privacy, fair use, piracy, or other concern, like storage or compute capacities. In some embodiments, a domain specific language 132 may span a variety of concerns, such as those typical of a given product or service. For example, DSL 132 may be based on one or more of data privacy, fair use, and piracy concerns as they apply to distribution and use of applications on user devices 110, like application 115. Another DSL may be based on data privacy and piracy concerns as they apply to providing a service, like internet access, to a device (such as a device requesting access to a publicly accessible WiFi network, like at an airport or a coffee shop) or service address (such as a user's home address). Thus, while one example DSL 132 is illustrated for convenience, different DSLs may be specified for different domains.

In some embodiments, an authority 130 may publish a record of a DSL to a directed acyclic graph 105. At least conceptually, that record may be stored as node content in a node of the graph in a block of the graph. For example, the authority 130 may publish a record of DSL 132, and a block 11 may contain a record 1 with information about the DSL. The DSL information stored within record 1 may, as described above, take different form depending on the embodiment. For example, the record 1 may include the DSL in its entirety (which may be a structured version of the DSL, like in JSON or XML code and/or other representation like plaintext, or multiple), a cryptographic hash digest of the DSL, a hash digest of components of the DSL where the hash digest includes hashes of the different components of the DSL which themselves may be stored in other records, or multiple thereof.

The record 1 may be referenced by an address, such as an address of a node within the graph 105 storing the record 1. Entities may access or reference the DSL stored within the graph 105 based on the address. In some embodiments, the authority 130 includes an API 135 by which one or more entities may, for example, request an address of a record and other information.

In some embodiments the authority 130 provides an application, such as privacy application 113, configured to interface with the API 135 of the authority, other APIs, and/or the directed acyclic graph 105. Users may utilize a user-facing version of the application, like privacy application 113A, to specify preferred requirements/criteria for assets based on a domain specific language, negotiate requirements/criteria for assets, and/or execute assets. Providers may utilize a provider-facing version of the application, like privacy application 113B, to specify requirements/criteria for assets as they pertain to the different products and services they provide based on a domain specific language, negotiate requirements/criteria for assets, and/or execute assets.

In some example embodiments, a provider 120 executes a privacy application 113B to specify requirements and criteria for an asset. For example, the provider 120 may execute the privacy application 113B to specify requirements and criteria for an asset governing use of an application 115. The privacy application 113B may include an interface 117B configured to display information on a display of or coupled to the provider device 120. For example, the application 113B may query the authority 130, e.g., via API 135, to retrieve information about available DSLs 132 and/or ontologies of concerns 133. In turn, the interface 117B may display a listing thereof. The application 113B may transmit a selection of a concern and/or DSL to the authority 130 to retrieve information for the selected DSL or information for a DSL covering the selected concern.

Different embodiments may retrieve different information for the DSL from different sources. For example, the authority 130 may provide the DSL, which may be a structured version of the DSL, like XML or JSON code, part of the DSL, an address of the DSL within the graph 105, and/or other information pertaining to the DSL. In the case of receiving an address of the DSL within the graph 105, the application 113B may additionally retrieve a record, like record 1, from the graph. The DSL information stored in record 1 may have a same or different type as that provided by the authority 130. The DSL information stored in the record 1 may be used for verification of information provided by the authority 130, contain the DSL, or contain less or more information than provided by the authority, in accordance with the various embodiments described herein. For example, the authority 130 may provide an address of the record 1 and application 113B retrieves the record to retrieve information about the DSL, or provide an address of the record 1 and the DSL such that the application 113B accesses the record to retrieve a cryptographic hash of the DSL for verifying the authenticity of the DSL provided by the authority.

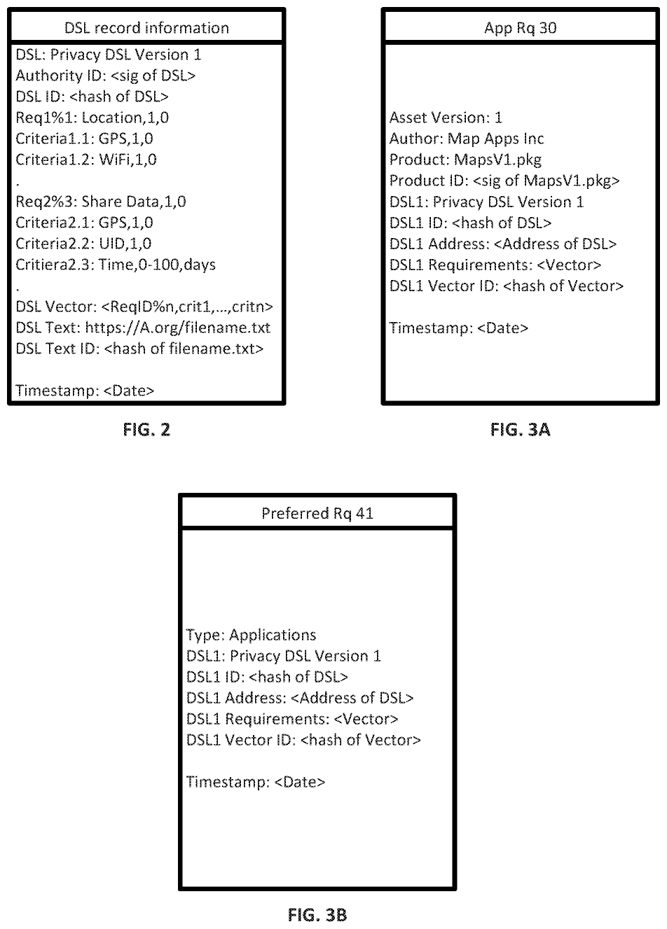

FIG. 2 illustrates an example record in a domain specific language, according to some embodiments, which may stored on a blockchain computing platform and referenced by an address on the blockchain computing platform, like an address of a leaf node (or set of leaf nodes) of a Merkle tree or Radix tree of a block in a blockchain. For example, the DSL record may specify a name of the DSL, like privacy DSL version 1, authority ID like a signature of record information such that another entity can verify the appropriate authority created the record, an ID of the DSL, which may be a hash of the domain specific language which other entities may verify. The record may also specify one or more requirements, like req1 and req2, in a given format. Criteria may also be included for the respective requirements as applicable. In some embodiments, a character, like %, may be used to delineate a number of criteria for a requirement id, like Req1, which may be a hash identifier of the requirement, address or other identifier. DSL vector may specify a format for constructing the vector based on the requirements and criteria. DSL text may reference a file containing a full DSL specification, or that information may be included in the record itself. The DSL specification may indicate that 1=YES, 0=No, and other information for translating different requirements and their criteria between different formats. For example, a high level representation for Req1 might be, This application collects location (GPS WiFi) data: YES/NO, and another representation, like a legal representation, might be, The user authorizes the provider to collect GPS location data as reported by the application in association with the user's use of the application to request data from the provider's servers. The cryptographic hashes and signature of the authority afford verification of any of the information within the record, and publication of the record to the blockchain insures that record information is not modified, i.e., by verifying cryptographic hash pointers based on the record. The record may also include a timestamp, and/or additional or other information. In some embodiments, the record may include key-value pairs like those present in the illustrated example of FIG. 2 and delimited by reserved terms (like a colon) with end of line characters delimiting key-value pairs, and in some cases, including a timestamp indicative of when the record was created (e.g., when the record was formed or when the record was signed).

Returning to FIG. 1, the application 113B may retrieve information about the DSL as described above. In some embodiments, the application 113B may verify the retrieved information about the DSL, such as by computing a cryptographic hash of received information for comparison with a retrieved cryptographic hash, and/or verifying authenticity of a record of the DSL within the graph 105, such as by computing one or more cryptographic hashes based on the record, one or more nodes, and/or blocks. The application 113B may perform the verification, perform part of the verification, or receive a result of verification from another entity in accordance with the various embodiments described herein.

In some embodiments, the application 113B may be configured to parse received information about a DSL, like DSL 132, to identify requirements and criteria specified in the DSL. In some embodiments, the application 113B may be configured to execute a structured version or portion of a DSL, like an XML or JSON script, which identifies requirements and criteria specified in the DSL. The application 113B is configured to display the requirement and the criteria specified in the DSL via the UI 117B. For example, the UI 117B may display a listing of requirements and their respective criteria (if any), options to select one or more requirements, and an option to enter or select criteria for the selected options. Based on those selections, the application 113B generates one or more listings of the selected requirements and criteria based on the DSL. Each listing may be at a different level specified by the DSL. For example, one listing may be in a vector format, one listing may be in an informational format, and one listing may be in a legal format. As the DSL is operable to translate information at one level of granularity to any other level of granularity, the application 113B may only generate a low level representation, such as a vector, and a reference to the DSL on which the vector was constructed. The application 113B having retrieved the information about the DSL, may display (e.g., via UI 117B) or report the selections at any level by translating the vector based on the DSL.

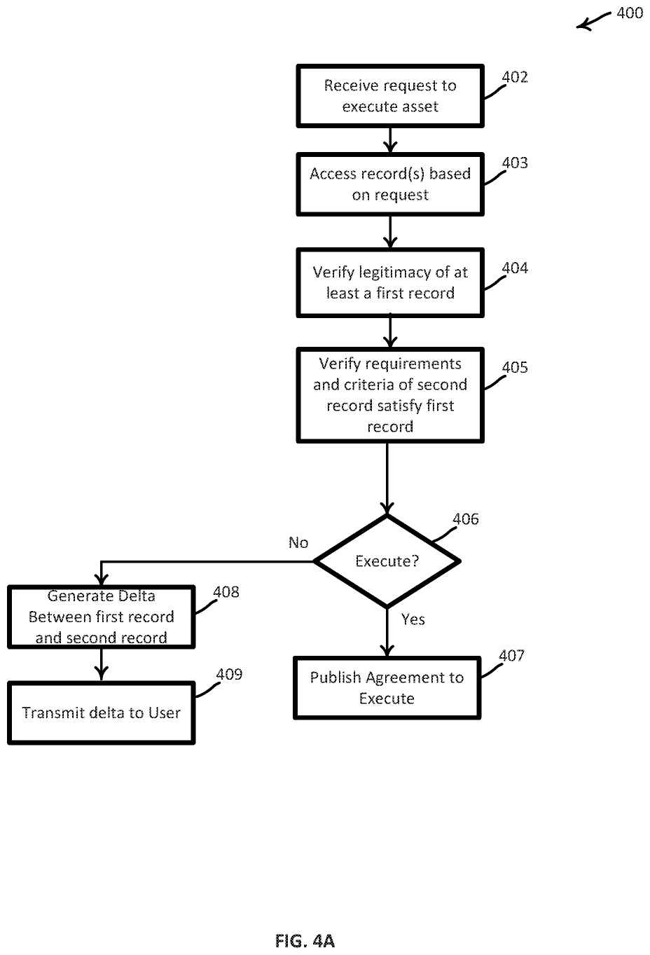

In some embodiments, the application 113B may be configured to store one or more listings of selected requirements and criteria, like a record of the selections and associated information. In some embodiments, this record is an asset. For example, the application 113B the provider 120 may select requirements and criteria of the DSL for governing use of the application 115, which may be stored as App Rq 30 record. The App Rq 30 record may include, for example, information about the selections of requirements and criteria, an identifier of the DSL from which they were selected, and an identifier of the product or service to which they pertain. All or some of this information may be stored in vector format or other serialization format. In some cases, the App Rq 30 record may be arranged in a hierarchical format, for instance a hierarchical data serialization format, like JSON or XML. In some embodiments, the App Rq 30 record may include key-value pairs like those present in the illustrated example of FIG. 3A and delimited by reserved terms (like a colon) with end of line characters delimiting key-value pairs, and in some cases, including a timestamp indicative of when the record was created (e.g., when the record was formed or when the record was signed).

FIG. 3A illustrates an example asset record of App Rq 30, according to some embodiments. For example, the App Rq 30 may specify an asset version, author (e.g., the provider), the product or service to which the asset applies (e.g., MapsV1.pkg), a product ID (e.g., a cryptographic signature of the package file), a name of a DSL, an identifier of the DSL (e.g., a hash of the DSL), an address of the DSL (e.g., of a record of the DSL either on blockchain or a file location), selected requirements and criteria from the DSL (e.g., a vector representation of the selected requirements and their criteria), a vector ID (e.g., a cryptographic hash of the vector), timestamp, and/or additional or other information. Examples of other or additional information may include the identification of a feature of a product or service level, one or more additional DSLs and associated information, and/or an address to a previous version.

Returning to FIG. 1, in some embodiments records may be stored in the directed acyclic graph 105 described above and thus, may be tamper-evident, immutable decentralized records. For example, a provider may utilize the privacy app 113B to publish a record, like a record of app req 30 to the graph 105, such as record 2. Published record 2 may include the information within the app req 30 and/or a cryptographic hash based on the app req 30 record such that a party may verify that an obtained copy of app req 30 is that on which record 2 is based. In some embodiments, the privacy application 113B submits record information for publication to at least one computing node 100 of the decentralized computing platform. Alternatively, the privacy application 113B may submit record information for publication to the authority 130, which in turn submits record information for publication to at least one computing node of the decentralized computing platform. In some embodiments, one or more of the authority 130 and provider 120 may function as a computing node 100 within the decentralized computing platform. As published records contained in node content within in the graph 105 are published and built on subject to consensus of a plurality of computing nodes 100, the provider 120 can subsequently verify that the published app rq information in record 2 matches the app rq 30 the provider specified for publication. In some embodiments, the provider 120 generates a cryptographic signature of the record information for publication with a private key of a key pair such that another entity with a public key of the key pair can verify that the published information was, in fact, published by the provider 120 and has not been altered.

Once the app rq 30 are published to graph 105, e.g., in record 2, the provider 130 may reference the record 2 in communications with other entities, such as for agreement upon an asset corresponding record 2. Additionally, the provider 130 may reference record 2 to specify changes in requirements or criteria to the corresponding asset, or reference additional products, features, or services for which the asset governs. For example, if the provider 120 of application 115 includes a feature governed by additional or other requirements or criteria, such as a location based feature, those additional requirements and criteria may govern what data is collected, how and when that data is collected, and how the collected data is used by the provider. The provider 120 may select those additional requirements and criteria in a fashion similar to that described above, such as via the privacy application 113B by making selections via the UI 117B. In addition, the UI 117B may include an option to reference an existing record, e.g., record 2, by an address of that record. Thus, for example, the requirements and criteria for that feature may be selected as they pertain to that feature and stored in an asset record feature rq 31. The asset record feature rq 31 may also contain reference to and existing record, like record 2, and the information in the feature rq 31 may take precedence over the information in record 2. For example, the feature rq 31 may include a vector identifying the new/changed requirements and criteria over the requirements and criteria corresponding to record 2, or include a vector identifying the totality of requirements and criteria for the feature in which case the reference to record 2 may be utilized to obtain the requirements and criteria corresponding to record 2 for a comparison to indicate the changes. In either instance, the privacy application 113B may publish a record of the feature requirements 31 in a similar fashion to the app rq 30. In turn, a record 4 including the published feature requirements, FRq, and included in block 13, may be referenced as corresponding to the requirements and criteria for an asset governing that feature.

Providers 120 of other types of products and services may create assets in a fashion similar to that described above, but a different domain specific language may be specified for that type of asset. For example, application requirements 30 may be one type, and service requirements 32 may be another type. Additional feature requirements 33 for the type of service requirements 32 may also be specified in a similar fashion to that described above for application features. However, in the cases of services, these addition features may be different guarantees of level of service or other types of requirements, such as in home vs mobile coverages.

A user may use a user device 110 to execute a privacy application 113A to specify preferred requirements and criteria for an asset. For example, the user device 110 may execute the privacy application 113A to specify requirements and criteria which they prefer, i.e., that they are willing to agree to those requirements and criteria. They specify those requirements and criteria for different domain specific languages (e.g., DSL 132) or more generally proceed through one or more ontologies of concerns 133 and answer questions to indicate requirements and criteria that are included in DSLs. For example, for DSL 132, which may govern use of a type of application, like a use application for consumption on user devices 110, the privacy application 113A may include an interface 117A configured to display information on a display of the user device 110. For example, the application 113A may query the authority 130, e.g., via API 135, to retrieve information about DSL 132 and/or ontologies of concerns 133. In turn, the interface 117A may display a listing thereof. The application 113A may transmit a selection of a concern and/or DSL to the authority 130 to retrieve information for the selected DSL or information for a DSL covering the selected concern.

Different embodiments may retrieve different information for the DSL from different sources. For example, the authority 130 may provide the DSL, which may be a structured version of the DSL, like XML or JSON code, part of the DSL, an address of the DSL within the graph 105, and/or other information pertaining to the DSL. In the case of receiving an address of the DSL within the graph 105, the application 113A may additionally retrieve a record, like record 1, from the graph. The DSL information stored in record 1 may have a same or different type as that provided by the authority 130. The DSL information stored in the record 1 may be used for verification of information provided by the authority 130, contain the DSL, or contain less or more information than provided by the authority, in accordance with the various embodiments described herein. For example, the authority 130 may provide an address of the record 1 and application 113A retrieves the record to retrieve information about the DSL, or provide an address of the record 1 and the DSL such that the application 113A accesses the record to retrieve a cryptographic hash of the DSL for verifying the authenticity of the DSL provided by the authority.

The application 113A may retrieve information about the DSL as described above. In some embodiments, the application 113A may verify the retrieved information about the DSL, such as by computing a cryptographic hash of received information for comparison with a retrieved cryptographic hash, and/or verifying authenticity of a record of the DSL within the graph 105, such as by computing one or more cryptographic hashes based on the record, one or more nodes, and/or blocks. The application 113A may perform the verification, perform part of the verification, or receive a result of verification from another entity in accordance with the various embodiments described herein.

In some embodiments, the application 113A may be configured to parse received information about a DSL, like DSL 132, to identify requirements and criteria specified in the DSL. In some embodiments, the application 113A may be configured to execute a structured version or portion of a DSL, like an XML or JSON script, which identifies requirements and criteria specified in the DSL. The application 113A is configured to display the requirement and the criteria specified in the DSL via the UI 117A. For example, the UI 117A may display a listing of requirements and their respective criteria (if any), options to select one or more requirements, and an option to enter or select criteria for the selected options. The selection of a criteria by a user may be considered a value. For example, whereas a provider might select criteria indicating >30 days, the user may specify a value, like 35, representative of no more than 35 days. For the different criteria, the user may select values for the criteria. Based on those selections, the application 113A generates one or more listings of the selected requirements and criteria (values) based on the DSL. Each listing may be at a different level specified by the DSL. For example, one listing may be in a vector format, one listing may be in an informational format, and one listing may be in a legal format. As the DSL is operable to translate information at one level of granularity to any other level of granularity, the application 113A may only generate a low level representation, such as a vector, and a reference to the DSL on which the vector was constructed. The application 113A having retrieved the information about the DSL, may display (e.g., via UI 117A) or report the selections at any level by translating the vector based on the DSL.

In some embodiments, the application 113A may be configured to store one or more listings of selected requirements and criteria, like a record of the selections and associated information. In some embodiments, this record represents preferred (or pre-agreed upon) requirements 41 which the user is willing to agree to for execution of an asset. All or some of this information may be stored in vector format or other serialization format. In some cases, the PRq 41 record may be arranged in a hierarchical format, for instance a hierarchical data serialization format, like JSON or XML. In some embodiments, the PRq 41 record may include key-value pairs like those present in the illustrated example of FIG. 3B and delimited by reserved terms (like a colon) with end of line characters delimiting key-value pairs, and in some cases, including a timestamp indicative of when the record was created (e.g., when the record was formed or when the record was signed).

FIG. 3B illustrates an example preferred (or acceptable) requirement record of PRq 41, according to some embodiments. For example, the PRq 41 may specify a type of asset to which the requirements apply, like user applications, a name of a DSL, an identifier of the DSL (e.g., a hash of the DSL), an address of the DSL (e.g., of a record of the DSL either on blockchain or a file location), selected requirements and their values (e.g., the user's preferred criteria) from the DSL (e.g., a vector representation of the selected requirements and their criteria), a vector ID (e.g., a cryptographic hash of the vector), timestamp, and/or additional or other information. Examples of other or additional information may include the identification of a feature of a product or service level, one or more additional DSLs and associated information, and/or an address to a previous version.

For example, returning to FIG. 1, once the PRq 41 is published to graph 105, e.g., in record 3, the user may reference the record 3 in communications with other entities, such as for agreement upon an asset. Additionally, the user may reference record 3 to specify changes in requirements or values to which they agree, either as preferred requirements or as accepted requirements (e.g., App ARq 42) for a particular asset. For example, if the provider 120 of application 115 includes a feature governed by additional or other requirements or criteria, such as a location based feature, the requirements and/or criteria specified for that additional feature may go beyond the user's preferred requirements. In which case, the user may elect in the privacy application 113A to create accepted requirements ARq 42 specific to that application in a fashion similar to that described above, such as by reviewing the requirements and selecting values that conform to the required criteria via the privacy application 113A by making selections via the UI 117A. In addition, the UI 117A may include an option to reference an existing record, e.g., record 2, by an address of that record. Thus, for example, the requirements and criteria for that feature may be selected as they pertain to that feature and stored in an asset record feature Rq 31. The asset record feature Rq 31 may also contain reference to and existing record, like record 3, and the information in the App ARq 42 may take precedence over the information in record 3. For example, the App ARq 42 may include a vector identifying the new/changed requirements and values over the preferred requirements and values corresponding to record 3, or include a vector identifying the totality of requirements and criteria for the feature in which case the reference to record 3 may be utilized to obtain the requirements and criteria corresponding to record 3 for a comparison to indicate the changes. In either instance, the privacy application 113A may publish a record of the ARqs 42 in a similar fashion to the PRq 41. In turn, a record 5 including the published ARqs, and included in block 13, may be referenced as corresponding to the requirements and criteria for an asset governing that feature (e.g., as specified by FRq in a record 4).

Some embodiments records may be stored in the directed acyclic graph 105 described above and thus, may be tamper-evident, immutable decentralized records. For example, a user may utilize the privacy app 113A on the user device 110 to publish a record, like a record of preferred requirements 41 to the graph 105, such as record 3. Published record 3 may include the information within the PRq 41 and/or a cryptographic hash based on the PRq 41 record such that a party may verify that an obtained copy of PRq 41 is that on which record 3 is based. In some embodiments, the privacy application 113A submits record information for publication to at least one computing node 100 of the decentralized computing platform. Alternatively, the privacy application 113A may submit record information for publication to the authority 130, which in turn submits record information for publication to at least one computing node of the decentralized computing platform. In some embodiments, one or more of the authority 130 and provider 120 may function as a computing node 100 within the decentralized computing platform. As published records contained in node content within in the graph 105 are published and built on subject to consensus of a plurality of computing nodes 100, the user can subsequently verify that the published PRq information in record 3 matches the PRq information they specified for publication via the privacy application 113A. In some embodiments, the user device 110 generates a cryptographic signature of the record information for publication with a private key of a key pair such that another entity with a public key of the key pair can verify that the published information was, in fact, published by the user device 110 and has not been altered.

In some embodiments, users of user devices and providers of products and services transmit public keys to the authority 130, which may catalog the keys and maintain records of information about the user and the providers such that users and providers may be held accountable. To that end, the authority 130 may also provided within the privacy application 113A a key pair generator such that users and providers may generate a private key which remains secret, e.g., on device, and the public key is provided to the authority for cataloging.

In some cases, each of the functional blocks of the illustrated logical architecture may be implemented in a different software module, application, in some cases process or computing device, for instance, in different virtual machines, containers, or the like. Or any subset or all of the described functionality may be aggregated in one or more computing devices. In some cases, this functionality may be implemented with program code stored on a tangible, non-transitory, machine-readable medium, such that when that program code is executed by one or more processors, the described functionality is effectuated, as is the case with the functionality described herein with reference to each of the figures. In some cases, notwithstanding use of the singular term “medium,” the program code may be distributed, with different subsets of the program code stored in memory of different computing devices that provide different subsets of the functionality, an arrangement consistent with use of the singular term medium herein.

In some embodiments, the environment 10 includes components controlled by a plurality of different entities, in some cases, different organizations or individuals, and in some cases, those different entities may not coordinate with one another or trust one another. Thus, in some cases, the computing environment 10 may operate without a central authority designating records as authoritative, designating determinations of (or logic of) certain scripts as authoritative, or gating access to the described records. Or in some cases, subsets may be implemented with permissioned, trusted computing environments or hybrid permissioned trusted computing environments and untrusted permissionless computing environments.

In some embodiments, each of, or various subsets of, the various blocks of functionality and/or devices depicted in computing environment 10 may have a respective public-private cryptographic key pair. In some embodiments, the respective public-private cryptographic key-pair of a given block of functionality and/or given device may be that of a user of the given block or given device. For example, in the case of a user device, a key pair may be created by the user on the user device, such as via an application, or a previously existing key pair input by the user either directly or via a peripheral device, such as a device storing the key pair. A user device may store different key-pairs for different users of the device or receive different key pairs from different users, such as via different devices of the respective users storing respective key pairs. In other instances, a key pair may correspond to that used by a company or other entity, or a registered key pair corresponding to that company or entity and utilized by a respective block managed by the company or entity.

In some embodiments, there may be multiple instances of individual ones of the depicted functional blocks, such as multiple providers of applications or services, multiple user devices, and/or multiple authorities, and each instance may have a respective unique public-private cryptographic key pair (or in some cases, multiple unique key pairs such as a key pair for each user account of a user device). In some embodiments, an output, and in some cases requests or other commands from the various illustrated components may be cryptographically signed with the private key of these key pairs by the component producing the output. In some embodiments, the private cryptographic keys may be stored locally on a computing devices on which the various components execute, for example, in a region of an address space accessible by the respective component, and the private cryptographic keys may be kept secret from other entities, and in some cases stored in encrypted form or held within a secure element of the local computing device and accessed via interrupts by requesting a separate secure coprocessor, different from a processor executing the illustrated component, to cryptographically sign a message. In some cases, the public cryptographic keys of the various components may be accessible to the other components, for example, stored in an index that associates identifiers of various instances of components with their public cryptographic key, and messages may be sent bearing those identifiers to facilitate confirmation at a receiving computing component that the message was sent by an entity with access to a private cryptographic key corresponding to the purported sender.

Cryptographic signatures may take various forms. In some embodiments, a component may cryptographically sign a message by computing a cryptographic hash digest based on the message, for instance, by inputting both the message, an identifier of the signing entity, and a timestamp into a cryptographic hash function to output a cryptographic hash value. In some embodiments, this cryptographic hash value may then be encrypted with the private encryption key. The resulting ciphertext may then be sent with the message (including the entity identifier and timestamp) to a recipient component, e.g., via publishing the message to a blockchain or directly. The recipient component may then retrieve a public cryptographic key corresponding to the sender's identifier (e.g., via the above-described index), decrypt the ciphertext with the public key, and access the cryptographic hash value therein.

The receiving component may than recalculate the cryptographic hash digest based upon the received message, re-creating the operations performed by the sender and determine whether the re-created cryptographic hash digest matches the decrypted cryptographic hash digest extracted by decrypting the ciphertext with the public cryptographic key of the purported sender. Upon determining that the hash digests match, the receiving component may determine that the message was sent by the purported sender and that the message was unaltered between being received and being signed. In some cases, messages be may be sent by writing the messages to a public repository or other repository for later consumption by recipient, or messages may be sent directly, for example, with application program interface calls, emails, remote procedure calls, and the like.

In some embodiments, the cryptographic hash digests described herein may be calculated by inputting values to be hashed into various hash functions, examples including MD5, SHA-256, SHA-384, SHA-512, SHA-3, and the like. The cryptographic hash function may intake an input of arbitrary length and produce an output of fixed length (e.g., with the Merkle-Damgård construction). The cryptographic hash function may be deterministic and impose a relatively low computational load relative to attempts to compute a hash collision (e.g., consuming less than 1/100,000^{th} the computing resources). In some cases, a change to any part of an input may produce a change in an output of the cryptographic hash function, even if the change is as small as flipping a single bit.

In some embodiments, private and public cryptographic key pairs may be generated with various asymmetric encryption algorithms, examples including RSA, elliptic curve, lattice-based cryptography, and various post quantum asymmetric encryption algorithms. Or in some cases, encryption keys may be symmetric, and values may be encrypted by applying a relatively high entropy value, like a random value, known to both a sender and recipient (e.g., with a one-time pad or previously exchanged via an asymmetric encryption protocol) with an XOR operation to produce a ciphertext.

In some embodiments, authority 130 may serve as a proxy for the sender with respect to authenticating the sender to the recipient. For example, a sender may establish the authenticity of the sender's identity with the authority, for example, by supplying a cryptographic signature based upon a previously established private-public cryptographic key registered with the authority or asymmetric cryptographic key known to the authority in the sender or passing an audit. The authority 130 may then cryptographically sign the message on behalf of the sender, in some cases appending to the message being signed an authenticated identity of the sender, thereby signing both the identity and the message in the cryptographic signature of the certificate authority. In some cases, recipients may then perform operations like those described above to verify the signature of the authority (e.g., with reference to public cryptographic key of the authority in a root certificate that is locally stored) and thereby verify both the sender as having been authenticated by the certificate authority and the message as having been unaltered since being signed. In some cases, a single authority may sign messages on behalf of a plurality of different senders, thereby simplifying key exchanges. For instance, a single root certificate stored on a receiver's computing device may be accessed to determine whether to authenticate signatures that purport to authenticate a plurality of different senders by operation of the authority 130.

In some embodiments, that authority 130 also manages the one or more domain specific languages by which the senders and recipients agree on assets. In other words, the certificate authority 130, may be a trusted third party through which requirements and criteria based on a domain specific language may be specified for an asset. Thus, users and providers may communicate information with the authority 130 for publication, such as on a graph in some embodiments and the authority 130 may provide users/providers indication that records for publication indicating agreement to an asset are to be published. In this way, users and providers can be assured of agreement without waiting for the record to be published for verification (although verification may be provided by the authority once a record indicating the agreement is published). In some embodiments, the authority 130 also performs comparisons on record to determine deltas between provider requirements for use of a product or service and the preferred requirements of users, such that a user may communicate a record of the user's agreement to those requirements and criteria which go beyond their preferred ones. In other embodiments, these operations may take place on the block chain, such as via a smart contract 107, which performs the comparison and transmits the delta, or both may work together with the authority providing some information in response to the execution of a smart contract and receive results of the execution of the smart contract to provide one or more indications to a user or a provider.

Thus, the records stored in the graph 105 may include a cryptographic signature of the record and optionally the authority. In turn, for example, when the user launches the application 115, the application may reference (e.g., by an address of) a record 2 of a block 12 corresponding to requirements governing use of the application 115. Alternatively, the application 115 may query the provider 120 for a current reference to a record governing its use. The application 115 may also make the reference of the record available in memory to the privacy application 113A. In turn, the privacy application 113A may obtain a reference to a record of the user's preferred requirements, identify other information, like a public key of the user stored on the user device, by which the preferred requirements of the user may be referenced. The privacy application 113A may provide this information, such as in a request, to the authority 130, such as via API 135, or to a smart contract 107.

The authority 130 and/or smart contract 107, in response to receiving the information in the request, may access the referenced records. If other information, like a public key of the user is provided, the smart contract 107 and/or authority 130 may determine a most recent record of preferred requirements for the asset type corresponding to asset type which the referenced record corresponds. In some cases, the smart contract 107 may cause the computing node 100 to query the authority 130 for some of the data, such as by querying the API 135 with the public key to receive a reference to the record of the user's preferred requirements.

If no record of the user's preferred requirement exists, the smart contract 107 and/or authority 130 may push a notification to the privacy app 113A, by which the user is notified to create preferred requirements 41 for the asset type or application specific requirements 42 record. In turn, the user device 110 may cryptographic sign the record, and which may serve as a verifiable record of the user's agreement to the requirements and values specified therein, in place of a record thereof on the blockchain. The application 113A may reinitiate the request with the signed record and the reference to record corresponding to the asset for execution.

Having obtained a record of the requirements and values the user agrees to, and a record of the requirements and values corresponding to the asset for execution, the smart contract 107 and/or the authority 130 determine that the requirements and values specified in the user record satisfies the requirements and criteria specified in the record corresponding to the asset. In order to perform the determining, the entity may retrieve one or more records corresponding to the domain specific language upon which the information in the record held by the user and the record held by the provider are based. For example, the smart contract 107 and/or authority 130 may contain logic to identify one or more key-value pairs referencing a domain specific language record or records of requirements and criteria of the domain specific language. The key-value pairs may be components of a hash digest such that the information of the record may be verified as corresponding to the information retrieved from the one or more records specifying the domain specific language. The records of the domain specific language may specify a format of the requirements and criteria, such that the requirements and criteria specified in the respective records for agreement to execution of the asset can be compared. Namely, the logic determines whether the requirements and values of the user record satisfy the requirements and criteria of the provider record based on the domain specific language.

Upon determination that the requirements and criteria of the provider record corresponding to the asset are satisfied by the user record, the smart contract 107 and/or authority 130 may cause a computing node 100 to publish a record of the result, such as by a record referencing the record of the user and the record of the provider. Additionally, the entity may return indication of the acceptance result, such as to the authority 130, the user device 110, and/or provider 120. In some cases the authority 130 may sign the result to indicate acceptance prior to publication. Alternatively, the application 113A and/or 113B may monitor for publication of the record such that a function based on the result can be implemented (e.g., the provider providing the application 115 access to an API or otherwise activating features of the application 115, etc., or the privacy application 113A providing the result to the application 115 to unlock a feature or enable execution).

In instances where the record of the user was provided as a cryptographically signed version rather than by reference in the graph 105, that record may be published as well for future reference and verification of agreement. Otherwise, agreement may be indicated by a signed request having a signature matching a signature of the user record being stored in a record with references to the user record and provider record upon which agreement was reached. Each step and information component like the records, requirements and criteria specified therein, and the DSL upon which each are based, being verifiable based on immutable records in the blockchain.

Upon determining that the requirements and criteria of the provider record corresponding to the asset are not satisfied by the user record, the smart contract 107 and/or authority 130 may transmit a delta, the delta indicating which requirement and which criteria of the record corresponding to the asset are not satisfied by the user record. In some cases, that delta may be pushed to the privacy application 113A having submitted the request such that user may specify additional accepted requirements and/or values for satisfying the criteria in a record, like App ARq 42, which may be cryptographically signed and submitted with a new request as a signed delta.

In some illustrated examples in FIG. 1, a single instance, or relatively few instances of each of the components of the computing environment 10 are shown, but it should be emphasized that there may be many more instances, and commercial embodiments are expected to include substantially more instances of each of the illustrated components, such as more than five of each, more than 50 of each, more than 500 of each, more than 5000 of each, or more than 50,000 of each, depending upon the size of the ecosystem built around the computing environment 10. In some cases, the number of transactions executed in ecosystems of this scale may be relatively large, examples including more than one transaction per minute, one transaction per second, 10 transactions per second, or 100 transactions per second on average over a trailing duration of one week. In some cases, some transactions may be relatively latency sensitive, for instance, with maximum or average transaction request response times being less than one minute, 10 seconds, one second, 500 ms, or 100 ms. In some cases, these transactions may read or write records, for instance, the records describe above, or determine results based on those records, as invoked by or performed by the various illustrated components for publication or verification.

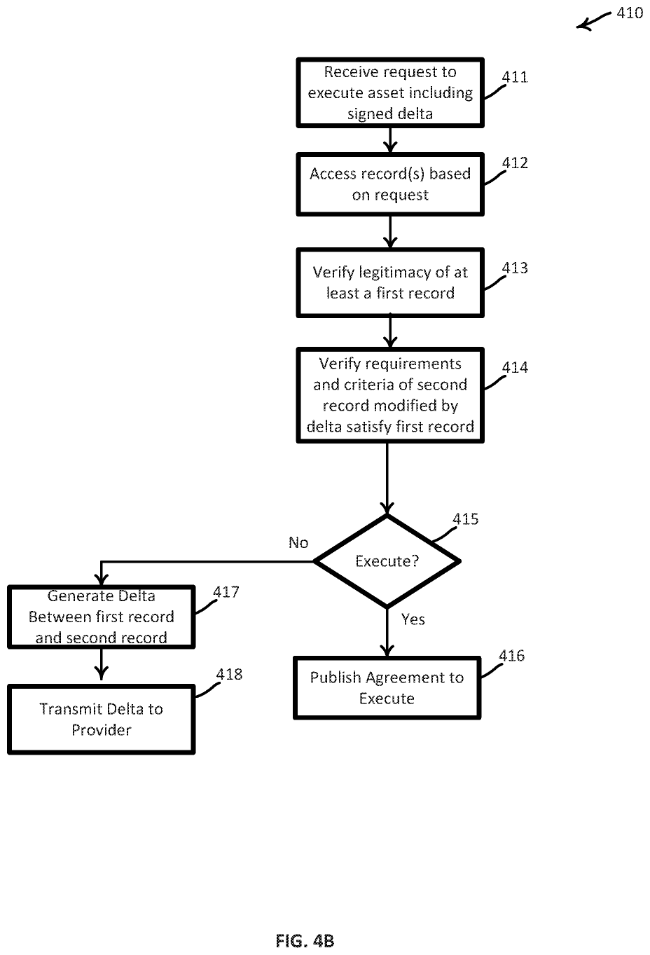

FIG. 4A shows an example of a process 400 by which the above-describe techniques may be implemented to determine whether to execute an asset based on records documenting requirements associated with the asset and published to a tamper-evident, immutable, decentralized data store, in some cases by executing the process 400 by one or more computing nodes 100 of the decentralized data store and/or an authority 130, though embodiments are not limited to that implementation, which is not to suggest that any other description herein is limiting. In some embodiments, the described functionality of FIG. 4A and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 400 receiving, with one or more processors, a request 402 to execute an asset between at least two record holders having documented one or more requirements from a set of requirements codified in a domain-specific language in the respective records.

In some embodiments, the process 400 includes accessing 403 one or more of the records specified in the request. The request may reference one or more records by address in the decentralized data store, by which the records may be accessed. For example, accessing the first record, the first record including a hash digest based on requirements associated with the asset, the hash digest implicating a plurality of requirements published to the tamper-evident, immutable, data store in at least one record, and accessing the second record, the second record including a hash digest based on accepted requirements associated with the type of asset, the hash digest implicating a plurality of requirements published to the tamper-evident, immutable, data store in at least one record. In some embodiments, a provider record, first record, and a user record, second record, corresponding to the asset, are accessed. Additional records corresponding to a DSL may be referenced in the use record and provider record, and the process 400 may further include accessing those records corresponding to the DSL to verify information about requirements and criteria specified in the user and provider records. In some embodiments, that information is a hash digest, by which hashes of information in the record serve to verify and/or reference records and/or information within the records. In some cases, the hash digest includes hashes for verifying information reference in a record but stored in an off-block record.

In some embodiments, the process 400 includes verifying legitimacy 404 of at least a first record. For example, the process 400 may verify the legitimacy of a provider record corresponding to an asset and subsequently verify the legitimacy of one or more records corresponding to the DSL upon which the provider record being based. Further, the process 400 may verify the legitimacy of a record by verifying limitary of the reference location of the record to ensure the referenced record on block is a legitimate record on block. For example, verifying the first record has not been tampered with subsequent to publishing by verifying that the first record is consistent with a set of cryptographic hash values based on the first record, at least some of the cryptographic hash values also being based on other records.

In some embodiments, the process 400 includes verifying 405 requirement and criteria of second record, such as a user record, satisfy those of a first record, such as a provider record corresponding to an asset for agreement. For example, identifying, within the first record, one or more criteria associated with one or more of the requirements; identifying, within the second record, one or more values associated with one or more of the requirements, verifying, for each of the plurality of requirements implicated in the first record, that the second record implicates a same requirement to satisfying the plurality of requirements implicated in the first record, verifying, for each of the criteria in the first record, that the second record includes a value satisfying the criteria specified in the first record.

In some embodiments, the process 400 includes determining 406 with one or more processors, whether to execute the asset based on a comparison of a first record documenting requirements associated with a given asset of a given type and a second record documenting accepted requirements associated with the type of asset, each record published to a tamper-evident, immutable, decentralized data store, the determination based on the verifying 405.

In some embodiments, the process 400 includes causing, with one or more processors, one or more computing devices to publish 407 to the tamper-evident, immutable data store an agreement to execution of the asset upon determining (YES) the requirements and the criteria of the first record are satisfied by the second record, or causing, with one or more processors, one or more computing devices to not execute the asset upon determining (NO) the requirements and the criteria of the first record are not satisfied by the second record.

In some embodiments, the process 400 includes for when the requirements and the criteria of the first record are not satisfied by the second record, generating 408 a delta between the first record and the second record, and causing the one or more processor to transmit 409 the delta indicating at least one of a requirement or requirement and criteria of the first record not satisfied by the second record.

FIG. 4B shows an example of a process 410 by which the above-described techniques may be implemented to determine whether to execute an asset based on records documenting requirements associated with the asset and published to a tamper-evident, immutable, decentralized data store, in some cases by executing the process 410 by one or more computing nodes 100 of the decentralized data store and/or an authority 130, though embodiments are not limited to that implementation, which is not to suggest that any other description herein is limiting. In some embodiments, the described functionality of FIG. 4B and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 410 receiving, with one or more processors, a request 411 to execute an asset between at least two record holders having documented one or more requirements from a set of requirements codified in a domain-specific language in the respective records. The request additionally includes a signed delta, such as for modifying a user record to include additional requirements and criteria not previously satisfied.

In some embodiments, the process 410 includes accessing 412 one or more of the records specified in the request. The request may reference one or more records by address in the decentralized data store, by which the records may be accessed. For example, accessing the first record, the first record including a hash digest based on requirements associated with the asset, the hash digest implicating a plurality of requirements published to the tamper-evident, immutable, data store in at least one record, and accessing the second record, the second record including a hash digest based on accepted requirements associated with the type of asset, the hash digest implicating a plurality of requirements published to the tamper-evident, immutable, data store in at least one record. In some embodiments, a provider record, first record, and a user record, second record, corresponding to the asset, are accessed. Additional records corresponding to a DSL may be referenced in the use record and provider record, and the process 400 may further include accessing those records corresponding to the DSL to verify information about requirements and criteria specified in the user and provider records. In some embodiments, that information is a hash digest, by which hashes of information in the record serve to verify and/or reference records and/or information within the records. In some cases, the hash digest includes hashes for verifying information reference in a record but stored in an off-block record.

In some embodiments, the process 410 includes verifying legitimacy 413 of at least a first record. For example, the process 410 may verify the legitimacy of a provider record corresponding to an asset and subsequently verify the legitimacy of one or more records corresponding to the DSL upon which the provider record being based. Further, the process 400 may verify the legitimacy of a record by verifying limitary of the reference location of the record to ensure the referenced record on block is a legitimate record on block. For example, verifying the first record has not been tampered with subsequent to publishing by verifying that the first record is consistent with a set of cryptographic hash values based on the first record, at least some of the cryptographic hash values also being based on other records. Further, the process 410 may include verifying a signature of the delta matches a signature of the second record of the user, i.e., that the user having created the record also created the delta.

In some embodiments, the process 410 includes verifying 414 requirement and values of second record, such as a user record, satisfy those of a first record, such as a provider record corresponding to an asset for agreement. For example, identifying, within the first record, one or more criteria associated with one or more of the requirements; identifying, within the second record and the signed delta, one or more values associated with one or more of the requirements, verifying, for each of the plurality of requirements implicated in the first record, that the second record modified by the signed delta implicates a same requirement to satisfying the plurality of requirements implicated in the first record, verifying, for each of the criteria in the first record, that the second record modified by the signed delta includes a value satisfying the criteria specified in the first record.

In some embodiments, the process 410 includes determining 415 with one or more processors, whether to execute the asset based on a comparison of a first record documenting requirements associated with a given asset of a given type and a second record documenting accepted requirements associated with the type of asset, each record published to a tamper-evident, immutable, decentralized data store, the determination based on the verifying 405.

In some embodiments, the process 410 includes causing, with one or more processors, one or more computing devices to publish 416 to the tamper-evident, immutable data store an agreement to execution of the asset upon determining (YES) the requirements and the criteria of the first record are satisfied by the second record modified by the signed delta, or causing, with one or more processors, one or more computing devices to not execute the asset upon determining (NO) the requirements and the criteria of the first record are not satisfied by the second record.

In some embodiments, the process 400 includes for when the requirements and the criteria of the first record are not satisfied by the second record, generating 417 a delta between the first record and the second record, and causing the one or more processor to transmit 418 the delta indicating at least one of a requirement or requirement and criteria of the first record not satisfied by the second record. In some embodiments, this delta is sent to the user and the provider, as the user choose not to comply with the requirements and criteria. At this point, the provider may review their policies if large numbers of users refuse to agree to an asset. The user retains the ability to later update their requirements and reinitiate a request 411 including a signed record or delta to satisfy the provider's requirements and criteria.

In some embodiments, to expedite operations, one or more of the illustrated loops may be executed concurrently for a plurality of request on a plurality of the records indicated by those requests, for instance, many requests may be simultaneously processed by different nodes of a decentralized computing platform and consensus may be reached based on a most common or agreed upon output.

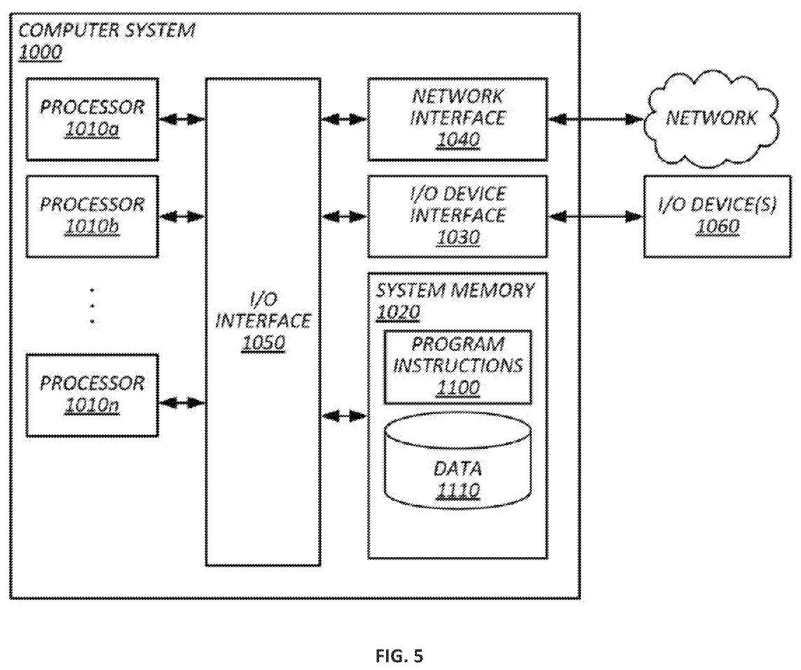

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 1020 may include a non-transitory computer readable storage medium that may have program instructions stored thereon that are executable by a computer processor (e.g., one or more of processors 1010a-101n) to cause the subject matter and the functional operations described herein. A memory (e.g., system memory 1020) may include a single memory device or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-101n, system memory 1020, network interface 1040, I/O devices 1060, or other peripheral devices. I/O interface 1050 may perform protocol, timing, or other data transformations to convert data signals from one component (e.g., system memory 1020) into a format suitable for use by another component (e.g., processors 1010a-101n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A method of determining whether to execute an asset based on records documenting requirements associated with the asset and published to a tamper-evident, immutable, decentralized data store, the method comprising: receiving, with one or more processors, a request to execute an asset between at least two record holders having documented one or more requirements from a set of requirements codified in a domain-specific language in respective records; determining, with one or more processors, whether to execute the asset based on a comparison of a first record documenting requirements associated with a given asset of a given type and a second record documenting accepted requirements associated with the type of asset, each record published to a tamper-evident, immutable, decentralized data store, wherein determining whether to execute the asset comprises: accessing the first record, the first record including a hash digest based on requirements associated with the asset, the hash digest implicating a plurality of requirements published to the tamper-evident, immutable, data store in at least one record, verifying the first record has not been tampered with subsequent to publishing by verifying that the first record is consistent with a set of cryptographic hash values based on the first record, at least some of the cryptographic hash values also being based on other records, identifying, within the first record, one or more criteria associated with one or more of the requirements; accessing the second record, the second record including a hash digest based on accepted requirements associated with the type of asset, the hash digest implicating a plurality of requirements published to the tamper-evident, immutable, data store in at least one record, identifying, within the second record, one or more values associated with one or more of the requirements, verifying, for each of the plurality of requirements implicated in the first record, that the second record implicates a same requirement to satisfying the plurality of requirements implicated in the first record, verifying, for each of the criteria in the first record, that the second record includes a value satisfying the criteria specified in the first record, and in response to the determination and the request either: causing, with one or more processors, one or more computing devices to publish to the tamper-evident, immutable data store an agreement to execution of the asset upon determining the requirements and the criteria of the first record are satisfied by the second record, or causing, with one or more processors, one or more computing devices to not execute the asset upon determining the requirements and the criteria of the first record are not satisfied by the second record, wherein the one or more computing devices transmit a delta indicating at least one of a requirement or requirement and criteria of the first record not satisfied by the second record.
2. The method of claim 1, wherein: the tamper-evident, immutable, decentralized data store comprises a directed acyclic graph of cryptographic hash pointers; at least some of the cryptographic hash pointers have cryptographic hash values based on content of adjacent nodes of the directed acyclic graph to which the cryptographic hash pointers point; and a subset of nodes of the directed acyclic graph have node content that includes at least part of the trust record or a hash digest of at least part of the trust record.
3. The method of any one of claims 1-2, wherein: the tamper-evident, immutable, decentralized data store comprises a blockchain.
4. The method of any one of claims 1-3, wherein: determining whether to execute the asset is performed by a smart contract executed by a plurality of computing nodes of a decentralized computing platform; and the plurality of computing nodes each execute an instance of the smart contract and then collectively determine an output of the smart contract with a consensus protocol.
5. The method of any one of claims 1-4, further comprising: receiving a second request to execute the asset, the second request including a digital signature and one or more accepted requirements and at least one value associated with a given one of the accepted requirements; verifying, based on the signature, the second request is authored by the holder of the second record; and determining, with one or more processors, whether to execute the asset based on a comparison of the first record and the one or more accepted requirements and at least one value associated with the given one of the accepted requirements in the second request.
6. The method of any one of claims 1-5, further comprising: receiving a second request to execute the asset, the second request including a digital signature, a hash digest based on accepted requirements associated with the type of asset, and at least one value associated with a given one of the accepted requirements, the hash digest implicating a plurality of requirements published to the tamper-evident, immutable, data store in at least one record; and determining, with one or more processors, whether to execute the asset based on a comparison of the first record and the one or more accepted requirements and at least one value associated with the given one of the accepted requirements in the second request.
7. The method of any one of claims 1-6, further comprising: receiving a second request to execute the asset, the second request including a digital signature and a second delta; verifying, based on the signature, the second request is authored by the holder of the second record; and determining, with one or more processors, whether to execute the asset based at least in part on the second delta.
8. The method of any one of claims 1-7, wherein: the first delta is published to the tamper-evident, immutable, data store in at least one record, the second delta indicates at least one of a requirement or requirement and value different from the second record, and determining whether to execute the asset comprises a comparison of the first delta and the second delta.
9. The method of any one of claims 1-8, wherein: determining, with one or more processors, whether to execute the asset based at least in part on the second delta comprises determining the second delta satisfies the first delta.
10. The method of any one of claims 1-9, wherein the second delta satisfies the first delta in response to at least one of: a match of a cryptographic hash of the second delta and a cryptographic hash of first delta, a comparison of the at least one of a requirement or requirement and criteria of the first record not satisfied by the second record indicated by the first delta and at least one of a requirement or requirement and value different from the second record indicated by the second delta, or a comparison of the first record and a modified version of the second record, wherein the modified version of the second record includes a change to at least one accepted requirement or accepted requirement and value indicated by the second delta.
11. The method of any one of claims 1-10, wherein the request comprises: a value written to a register of a hardware component of a computing device, the value corresponding to an address of the second record published to the tamper-evident, immutable, decentralized data store, and a signed value corresponding to a version or component of a software application and the first record, the signed value operable to identify an address of the first record published to the tamper-evident, immutable, decentralized data store.
12. The method of any one of claims 1-11, further comprising: monitoring, by the computing device, a blockchain for publication of the agreement to execution of the asset; and responsive to the publication, permitting execution of the version or component of the software application on the computing device.
13. The method of any one of claims 1-12, further comprising: monitoring, by a second computing device, a blockchain for publication of the agreement to execution of the asset; and responsive to the publication, activating the version or component of the software application on the computing device.
14. The method of any one of claims 1-13, comprising determining whether to execute the asset with operations comprising: reading a value written to a register of a hardware component of a computing device; based on the value, obtaining an address of the first record published to the tamper-evident, immutable, decentralized data store; and specifying the address of the first record in the request.
15. The method of any one of claims 1-14, determining whether to execute the asset comprises: accessing the plurality of requirements published to the tamper-evident, immutable, decentralized data store; verifying that the plurality of requirements are cryptographically signed by a trusted party corresponding to a public cryptographic key; verifying that the plurality of requirements have not been tampered with subsequent to publishing; and comparing the plurality of requirements to corresponding requirements in the set of requirements codified in the domain-specific language.
16. The method of any one of claims 1-15, wherein: the tamper-evident, immutable, decentralized data store is hosted by a permissionless, untrusted collection of network accessible computing devices; and the collection of network accessible computing devices are configured to determine a state of accepted requirements represented in records associated with users with operations including: demonstrating proof of work, storage, or stake; and among computing devices demonstrating proof of work, storage, or stake, executing a consensus protocol that designates an output version of the state of accepted requirements represented in records as authoritative.
17. A tangible, non-transitory, machine-readable medium storing instructions that when executed by a data processing apparatus cause the data processing apparatus to perform operations comprising: the operations of any one of embodiments 1-14.
18. A system, comprising: one or more processors; and memory storing instructions that when executed by the processors cause the processors to effectuate operations comprising: the operations of any one of embodiments 1-14.

What is claimed is:

1. A method of determining whether to execute an asset based on records documenting requirements associated with the asset and published to a tamper-evident, immutable, decentralized data store, the method comprising:
receiving, with one or more processors, a request to execute an asset between at least two record holders having documented one or more requirements from a set of requirements codified in a domain-specific language in respective records;
determining, with one or more processors, whether to execute the asset based on a comparison of a first record documenting requirements associated with a given asset of a given type and a second record documenting accepted requirements associated with the type of asset, each record published to a tamper-evident, immutable, decentralized data store, wherein determining whether to execute the asset comprises:
accessing the first record, the first record including a hash digest based on requirements associated with the asset, the hash digest implicating a plurality of requirements published to the tamper-evident, immutable, data store in at least one record,
verifying the first record has not been tampered with subsequent to publishing by verifying that the first record is consistent with a set of cryptographic hash values based on the first record, at least some of the cryptographic hash values also being based on other records,
identifying, within the first record, one or more criteria associated with one or more of the requirements;
accessing the second record, the second record including a hash digest based on accepted requirements associated with the type of asset, the hash digest implicating a plurality of requirements published to the tamper-evident, immutable, data store in at least one record,
identifying, within the second record, one or more values associated with one or more of the requirements,
verifying, for each of the plurality of requirements implicated in the first record, that the second record implicates a same requirement to satisfying the plurality of requirements implicated in the first record,
verifying, for each of the criteria in the first record, that the second record includes a value satisfying the criteria specified in the first record, and
in response to the determination and the request, either:
causing, with one or more processors, one or more computing devices to publish to the tamper-evident, immutable data store an agreement to execution of the asset upon determining the requirements and the criteria of the first record are satisfied by the second record, or
causing, with one or more processors, one or more computing devices to not execute the asset upon determining the requirements and the criteria of the first record are not satisfied by the second record, wherein the one or more computing devices transmit a delta indicating at least one of a requirement or requirement and criteria of the first record not satisfied by the second record.

2. The method of claim 1, wherein:
the tamper-evident, immutable, decentralized data store comprises a directed acyclic graph of cryptographic hash pointers;
at least some of the cryptographic hash pointers have cryptographic hash values based on content of adjacent nodes of the directed acyclic graph to which the cryptographic hash pointers point; and
a subset of nodes of the directed acyclic graph have node content that includes at least part of the trust record or a hash digest of at least part of the trust record.

3. The method of claim 1, wherein:
the tamper-evident, immutable, decentralized data store comprises a blockchain.

4. The method of claim 1, wherein:
determining whether to execute the asset is performed by a smart contract executed by a plurality of computing nodes of a decentralized computing platform; and
the plurality of computing nodes each execute an instance of the smart contract and then collectively determine an output of the smart contract with a consensus protocol.

5. The method of claim 1, further comprising:
receiving a second request to execute the asset, the second request including a digital signature and one or more accepted requirements and at least one value associated with a given one of the accepted requirements;
verifying, based on the signature, the second request is authored by the holder of the second record; and
determining, with one or more processors, whether to execute the asset based on a comparison of the first record and the one or more accepted requirements and at least one value associated with the given one of the accepted requirements in the second request.

6. The method of claim 1, further comprising:
receiving a second request to execute the asset, the second request including a digital signature, a hash digest based on accepted requirements associated with the type of asset, and at least one value associated with a given one of the accepted requirements, the hash digest implicating a plurality of requirements published to the tamper-evident, immutable, data store in at least one record; and
determining, with one or more processors, whether to execute the asset based on a comparison of the first record and the one or more accepted requirements and at least one value associated with the given one of the accepted requirements in the second request.

7. The method of claim 1, further comprising:
receiving a second request to execute the asset, the second request including a digital signature and a second delta;
verifying, based on the signature, the second request is authored by the holder of the second record; and
determining, with one or more processors, whether to execute the asset based at least in part on the second delta.

8. The method of claim 7, wherein:
the first delta is published to the tamper-evident, immutable, data store in at least one record,
the second delta indicates at least one of a requirement or requirement and value different from the second record, and
determining whether to execute the asset comprises a comparison of the first delta and the second delta.

9. The method of claim 7, wherein:
determining, with one or more processors, whether to execute the asset based at least in part on the second delta comprises determining the second delta satisfies the first delta.

10. The method of claim 9, wherein the second delta satisfies the first delta in response to at least one of:
a match of a cryptographic hash of the second delta and a cryptographic hash of first delta,
a comparison of the at least one of a requirement or requirement and criteria of the first record not satisfied by the second record indicated by the first delta and at least one of a requirement or requirement and value different from the second record indicated by the second delta, or
a comparison of the first record and a modified version of the second record, wherein the modified version of the second record includes a change to at least one accepted requirement or accepted requirement and value indicated by the second delta.

11. The method of claim 1, wherein the request comprises:
a value written to a register of a hardware component of a computing device, the value corresponding to an address of the second record published to the tamper-evident, immutable, decentralized data store, and
a signed value corresponding to a version or component of a software application and the first record, the signed value operable to identify an address of the first record published to the tamper-evident, immutable, decentralized data store.

12. The method of claim 11, further comprising:
monitoring, by the computing device, a blockchain for publication of the agreement to execution of the asset; and
responsive to the publication, permitting execution of the version or component of the software application on the computing device.

13. The method of claim 11, further comprising:
monitoring, by a second computing device, a blockchain for publication of the agreement to execution of the asset; and
responsive to the publication, activating the version or component of the software application on the computing device.

14. The method of claim 12, comprising determining whether to execute the asset with operations comprising:
reading a value written to a register of a hardware component of a computing device;
based on the value, obtaining an address of the first record published to the tamper-evident, immutable, decentralized data store; and
specifying the address of the first record in the request.

15. The method of claim 1, determining whether to execute the asset comprises:
accessing the plurality of requirements published to the tamper-evident, immutable, decentralized data store;
verifying that the plurality of requirements are cryptographically signed by a trusted party corresponding to a public cryptographic key;
verifying that the plurality of requirements have not been tampered with subsequent to publishing; and
comparing the plurality of requirements to corresponding requirements in the set of requirements codified in the domain-specific language.

16. The method of claim 1, wherein:
the tamper-evident, immutable, decentralized data store is hosted by a permissionless, untrusted collection of network accessible computing devices; and
the collection of network accessible computing devices are configured to determine a state of accepted requirements represented in records associated with users with operations including:
demonstrating proof of work, storage, or stake; and
among computing devices demonstrating proof of work, storage, or stake, executing a consensus protocol that designates an output version of the state of accepted requirements represented in records as authoritative.

17. A tangible, non-transitory, machine-readable medium storing instructions that when executed by one or more processors effectuate operations comprising:
receiving, with one or more processors, a request to execute an asset between at least two record holders having documented one or more requirements from a set of requirements codified in a domain-specific language in respective records;
determining, with one or more processors, whether to execute the asset based on a comparison of a first record documenting requirements associated with a given asset of a given type and a second record documenting accepted requirements associated with the type of asset, each record published to a tamper-evident, immutable, decentralized data store, wherein determining whether to execute the asset comprises:
accessing the first record, the first record including a hash digest based on requirements associated with the asset, the hash digest implicating a plurality of requirements published to the tamper-evident, immutable, data store in at least one record,
verifying the first record has not been tampered with subsequent to publishing by verifying that the first record is consistent with a set of cryptographic hash values based on the first record, at least some of the cryptographic hash values also being based on other records,
identifying, within the first record, one or more criteria associated with one or more of the requirements;
accessing the second record, the second record including a hash digest based on accepted requirements associated with the type of asset, the hash digest implicating a plurality of requirements published to the tamper-evident, immutable, data store in at least one record,
identifying, within the second record, one or more values associated with one or more of the requirements,
verifying, for each of the plurality of requirements implicated in the first record, that the second record implicates a same requirement to satisfying the plurality of requirements implicated in the first record,
verifying, for each of the criteria in the first record, that the second record includes a value satisfying the criteria specified in the first record, and
in response to the determination and the request, either:
causing, with one or more processors, one or more computing devices to publish to the tamper-evident, immutable data store an agreement to execution of the asset upon determining the requirements and the criteria of the first record are satisfied by the second record, or
causing, with one or more processors, one or more computing devices to not execute the asset upon determining the requirements and the criteria of the first record are not satisfied by the second record, wherein the one or more computing devices transmit a delta indicating at least one of a requirement or requirement and criteria of the first record not satisfied by the second record.

18. The medium of claim 17, further comprising:
receiving a second request to execute the asset, the second request including a digital signature and one or more accepted requirements and at least one value associated with a given one of the accepted requirements;
verifying, based on the signature, the second request is authored by the holder of the second record; and
determining, with one or more processors, whether to execute the asset based on a comparison of the first record and the one or more accepted requirements and at least one value associated with the given one of the accepted requirements in the second request.

19. The medium of claim 17, further comprising:
receiving a second request to execute the asset, the second request including a digital signature, a hash digest based on accepted requirements associated with the type of asset, and at least one value associated with a given one of the accepted requirements, the hash digest implicating a plurality of requirements published to the tamper-evident, immutable, data store in at least one record; and
determining, with one or more processors, whether to execute the asset based on a comparison of the first record and the one or more accepted requirements and at least one value associated with the given one of the accepted requirements in the second request.

20. The medium of claim 17, further comprising:
receiving a second request to execute the asset, the second request including a digital signature and a second delta;
verifying, based on the signature, the second request is authored by the holder of the second record; and
determining, with one or more processors, whether to execute the asset based at least in part on the second delta.
